(19) United States
(12) Patent Application Publication
(10) Pub. No.: US 2026/0148052 A1
(43) Pub. Date: May 28, 2026

(54) ARTIFICIAL INTELLIGENCE COMPUTING DEVICE

(71) Applicant: APACECORE PTE. LTD., Hsinchu County (TW)

(72) Inventor: Yi Ting Hsu, Hsinchu County (TW)

(73) Assignee: APACECORE PTE. LTD., Hsinchu County (TW)

(21) Appl. No.: 19/402,949

(22) Filed: Nov. 26, 2025

(30) Foreign Application Priority Data
Nov. 28, 2024 (TW) 113146102

(51) Int. Cl. G06N 3/063

(52) U.S. Cl. CPC G06N 3/063

(57) ABSTRACT

An artificial intelligence computing device including the following components is provided. A control die is disposed on a substrate. A memory die is positioned above the control die. The memory die includes a dynamic random-access memory (DRAM) for storing a machine learning model. One of the control die and the memory die includes a static random-access memory (SRAM). A deep learning processing unit is electrically connected to the memory die and is configured to execute the machine learning model.

### CROSS-REFERENCE TO RELATED APPLICATION

This application claims the priority benefit of Taiwan application serial no. 113146102, filed on Nov. 28, 2024. The entirety of the above-mentioned patent application is hereby incorporated by reference herein and made a part of this specification.

### BACKGROUND

### Technical Field

The disclosure relates to an artificial intelligence computing device having a new memory framework.

### Description of Related Art

Along with rapid development of large language model (LLM), its computing requirements are increasing day by day, and conventional memory frameworks are gradually unable to meet these requirements, especially in terms of processing speed and latency. Therefore, as an operation scale of the large language model expands, how to provide efficient and low-power memory with sufficient density has become a major challenge. Limitations of existing memory frameworks have prompted the industry to seek innovative solutions to meet the needs of the large language model in computational efficiency and energy management.

### SUMMARY

The disclosure provides an artificial intelligence computing device including the following components. A control die is disposed on a substrate. A memory die is positioned above the control die. The memory die includes a dynamic random-access memory (DRAM) for storing a machine learning model. One of the control die and the memory die includes a static random-access memory (SRAM). A deep learning processing unit is electrically connected to the memory die and is configured to execute the machine learning model.

In an embodiment of the disclosure, the static random-access memory is arranged in the memory die, and the dynamic random-access memory includes a column decoder, a row decoder, and a sense amplifier.

In an embodiment of the disclosure, the control die is configured to move a part of the machine learning model from the dynamic random-access memory to the static random-access memory, and the deep learning processing unit reads the part of the machine learning model from the static random-access memory.

In an embodiment of the disclosure, when the part of the machine learning model is stored in the static random-access memory, the control die is configured to perform pre-processing on the part of the machine learning model.

In an embodiment of the disclosure, the pre-processing includes format conversion and rearrangement.

In an embodiment of the disclosure, the static random-access memory is arranged in the control die.

In an embodiment of the disclosure, the control die transmits a part of the machine learning model to the deep learning processing unit.

In an embodiment of the disclosure, the deep learning processing unit stores intermediate data generated by executing the part of the machine learning model in the static random-access memory.

In an embodiment of the disclosure, after the part of the machine learning model is transmitted to the deep learning processing unit, the deep learning processing unit is configured to perform pre-processing on the part of the machine learning model.

In the artificial intelligence computing device, two different memories are provided, and advantages of the two memories are used to reduce power consumption and latency.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a cross-sectional view illustrating an artificial intelligence computing device according to an embodiment.

FIG. 2 is a cross-sectional view illustrating an artificial intelligence computing device according to another embodiment.

FIG. 3 is a system schematic view illustrating an artificial intelligence computing device according to an embodiment.

FIG. 4 is an operation flow chart of an artificial intelligence computing device 300 according to an embodiment.

FIG. 5 is a system schematic view illustrating an artificial intelligence computing device according to an embodiment.

FIG. 6 is an operation flow chart illustrating an artificial intelligence computing device 500 according to an embodiment.

### DESCRIPTION OF THE EMBODIMENTS

Some embodiments of the disclosure will be described in detail with reference to the accompanying drawings. The component symbols cited in the following description will be regarded as the same or similar components when the same component symbols appear in different drawings. These embodiments are only a part of the disclosure and do not disclose all possible implementations of the disclosure. Rather, these embodiments are merely examples of systems and methods within the scope of the disclosure.

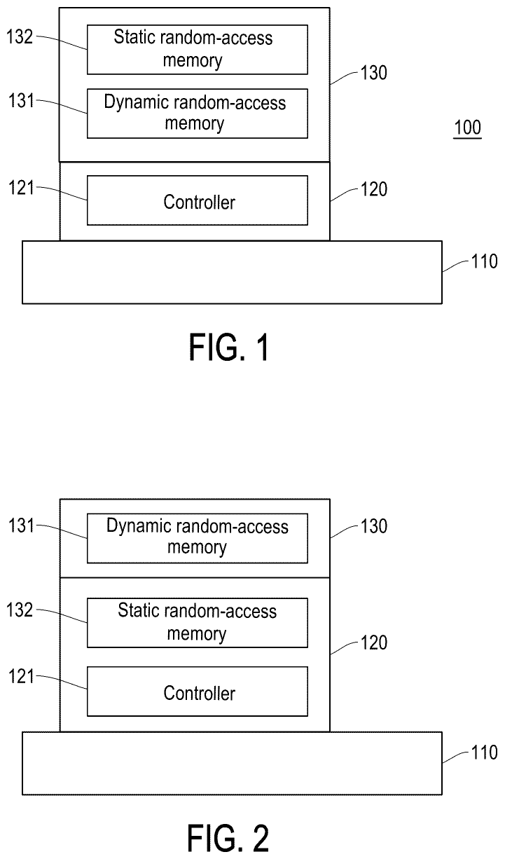

FIG. 1 is a cross-sectional view illustrating an artificial intelligence computing device according to an embodiment. Referring to FIG. 1, an artificial intelligence computing device 100 is used for a machine learning model. The machine learning model is, for example, a large language model. However, in other embodiments, it may also be an image processing model, which is not limited by the disclosure. The artificial intelligence computing device 100 includes a substrate 110, a control die 120, and a memory die 130. The control die 120 is disposed on the substrate 110, and the memory die 130 is disposed on the control die 120. In other words, the memory die 130 is stacked on the control die 120, and such a three-dimensional arrangement has advantages of reducing latency and saving space.

The control die 120 includes a controller 121. The controller 121 is configured to manage the entire system, such as receiving and processing instructions and control signals from the outside (such as a central processing unit), and coordinating operations between the memory die 130 and other components (such as a deep learning processing component, which will be described later).

The memory die 130 includes a dynamic random-access memory 131 and a static random-access memory 132. The advantages of the static random-access memory 132 include fast speed, low latency, and low power consumption (when static), but the disadvantages thereof are high cost, low density, and high dynamic power consumption. On the other hand, the advantages of the dynamic random-access memory 131 are high density and low cost, but the disadvantages thereof are that it needs to be refreshed regularly and is slower in speed. In the embodiment, a hybrid method of two types of memory is adopted, which may balance factors such as density, cost and speed. For example, the dynamic random-access memory 131 may be configured to store a large amount of data such as the entire machine learning model, while the static random-access memory 132 may be configured to store intermediate calculation results and other data that needs to be accessed quickly.

FIG. 2 is a cross-sectional view illustrating an artificial intelligence computing device according to another embodiment. A difference between FIG. 2 and FIG. 1 is that the static random-access memory 132 is disposed in the control die 120. In some embodiments, the static random-access memory 132 may be used as a buffer memory. Similarly, the dynamic random-access memory 131 may be configured to store a large amount of data, and the static random-access memory 132 may be configured to store data that needs to be accessed quickly.

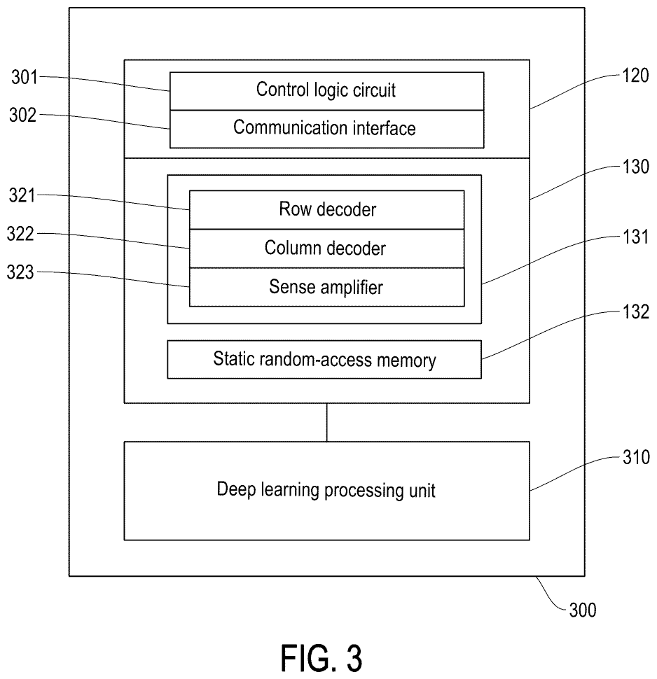

FIG. 3 is a system schematic view illustrating an artificial intelligence computing device according to an embodiment. Referring to FIG. 3, the system of FIG. 3 is designed based on the stacking of FIG. 1. An artificial intelligence computing device 300 further includes a deep learning processing unit 310, which may be disposed on the substrate 110 and electrically connected to the memory die 130. In some embodiments, the deep learning processing unit 310 may also be stacked on top of the memory die 130. In some embodiments, the deep learning processing unit 310 is also electrically connected to the control die 120.

The control die 120 includes a control logic circuit 301 and a communication interface 302. The control logic circuit 301 is in charge of operation, instruction decoding, timing control, etc., of the entire artificial intelligence computing device 300. The communication interface 302 may communicate with an external system and receive instructions and control signals. For example, the control logic circuit 301 may include a microprocessor, a microcontroller, application specific integrated circuits (ASIC), or a programmable logic device (PLD). The communication interface 302 is, for example, a universal serial bus (USB), a peripheral component interconnect express (PCIe), an inter-integrated circuit (I2C), a serial peripheral interface (SPI), a universal asynchronous receiver/transmitter (UART), etc., but the disclosure is not limited thereto.

The dynamic random-access memory 131 includes a row decoder 321, a column decoder 322, a sense amplifier 333, and related circuits (such as bit lines, word lines, etc.). Specifically, the dynamic random-access memory 131 includes a plurality of memory cells, which are arranged in a matrix. The row decoder 321 is configured to calculate row addresses, and the column decoder 322 is configured to calculate column addresses. The sense amplifier 333 is configured to read and amplify a tiny charge signal acquired from the memory unit, and convert the same into a stable logic signal (such as logic 0 or logic 1).

The deep learning processing unit 310 is configured to perform related operations of the machine learning model, including convolution, pooling, activation functions, matrix multiplication, etc., but the disclosure is not limited thereto.

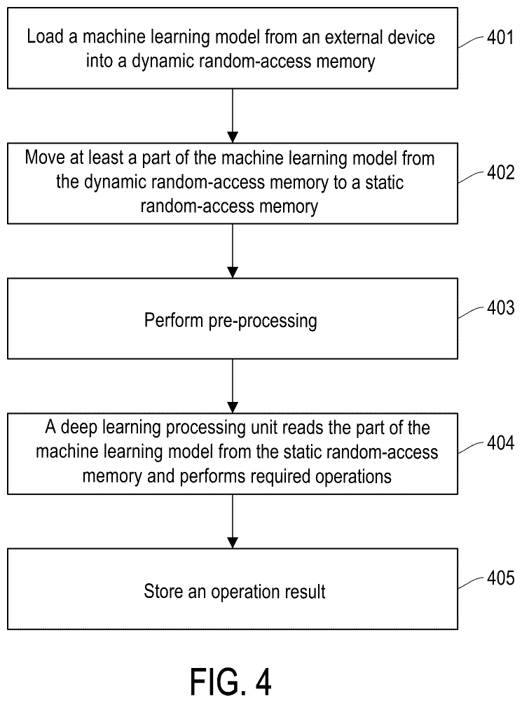

FIG. 4 is an operation flow chart of the artificial intelligence computing device 300 according to an embodiment. Referring to FIG. 3 and FIG. 4, in step 401, the control logic circuit 301 loads a machine learning model from an external device (for example, a hard disk, a flash memory) into the dynamic random-access memory 131. In step 402, the control logic circuit 301 moves at least a part of the machine learning model from the dynamic random-access memory 131 to the static random-access memory 132. In step 403, when the part of the machine learning model is stored in the static random-access memory 132, the control logic circuit 301 or the deep learning processing unit 310 performs pre-processing on the part of the machine learning model. The pre-processing may include format conversion and rearrangement. The format conversion may include normalization, changing an image size, color space conversion of pixels, converting text into tokens, etc. The rearrangement includes cutting continuous data into an input size required by the machine learning model, converting video into multiple images to form a feature map, etc., but the disclosure is not limited thereto. The pre-processed data is still stored in the static random-access memory 132.

In step 404, the deep learning processing unit 310 reads the part of the machine learning model from the static random-access memory 132, and performs required operations, such as convolution, pooling, activation function, matrix multiplication, etc. The use of the static random-access memory 132 has an advantage of low latency. In step 405, the deep learning processing unit 310 stores an operation result in an internal memory of the deep learning processing unit 310. In other embodiments, the deep learning processing unit 310 may also store the operation result in the static random-access memory 132. Finally, the control logic circuit 301 may return the operation result to a device that issued the related instruction (for example, a central processing unit).

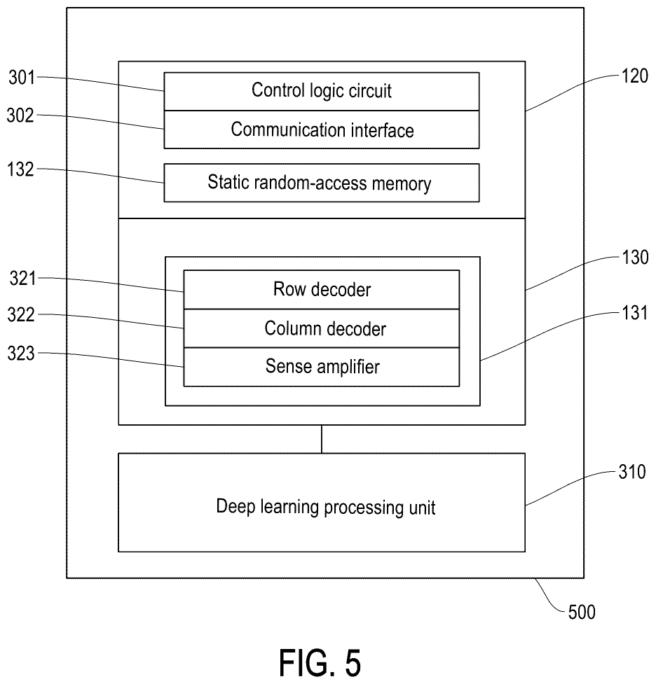

FIG. 5 is a system schematic view illustrating an artificial intelligence computing device according to an embodiment. A difference between FIG. 5 and FIG. 3 is that the static random-access memory 132 in an artificial intelligence computing device 500 is provided in the control die 120, and other components are similar to that of FIG. 3, so details thereof are not repeated.

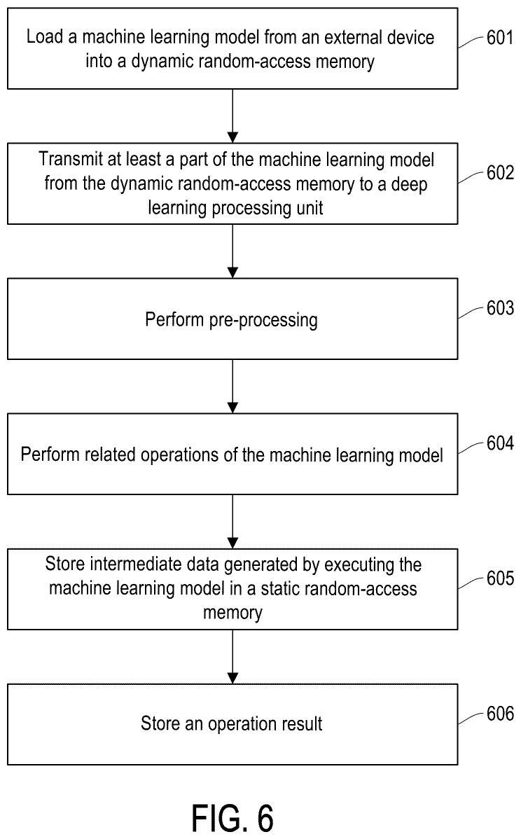

FIG. 6 is an operation flow chart illustrating the artificial intelligence computing device 500 according to an embodiment. Referring to FIG. 6, in step 601, the control logic circuit 301 loads a machine learning model from an external device (for example, a hard disk, a flash memory) into the dynamic random-access memory 131. In step 602, the control logic circuit 301 transmits at least a part of the machine learning model from the dynamic random-access memory 131 to the deep learning processing unit 310. In step 603, after the part of the machine learning model is transmitted to the deep learning processing unit 310, the deep learning processing unit 310 performs pre-processing on the part of the machine learning model. As described above, the pre-processing may include format conversion, rearrangement, etc., but the disclosure is not limited thereto. In step 604, the deep learning processing unit 310 performs related operations of the machine learning model. In step 605, the deep learning processing unit 310 stores intermediate data generated by executing the machine learning model in the static random-access memory 132. In some embodiments, the static random-access memory 132 may serve as a cache of the deep learning processing unit 310. Since the static random-access memory 132 has the advantage of fast speed, it may be used as a cache to accelerate a calculation speed of the machine learning model. In step 606, the deep learning processing unit 310 stores an operation result in an internal memory of the deep learning processing unit 310. In other embodiments, the deep learning processing unit 310 may also store the operation result in the static random-access memory 132. Finally, the control logic circuit 301 may return the operation result to the device that issued the instruction (for example, a central processing unit).

The above-mentioned artificial intelligence computing device has two types of memories stacked on each other, based on high-speed characteristics of the static random-access memory and high-density characteristics of the dynamic random-access memory, such combination may reduce power consumption and latency. The operating efficiency of the machine learning model is thereby improved.

It will be apparent to those skilled in the art that various modifications and variations can be made to the disclosed embodiments without departing from the scope or spirit of the disclosure. In view of the foregoing, it is intended that the disclosure covers modifications and variations provided they fall within the scope of the following claims and their equivalents.

What is claimed is:

1. An artificial intelligence computing device, comprising:
a substrate;
a control die, disposed on the substrate;
a memory die, positioned above the control die, wherein the memory die comprises a dynamic random-access memory for storing a machine learning model, and one of the control die and the memory die comprises a static random-access memory; and
a deep learning processing unit, electrically connected to the memory die and configured to execute the machine learning model.

2. The artificial intelligence computing device according to claim 1, wherein the static random-access memory is arranged in the memory die, and the dynamic random-access memory comprises a column decoder, a row decoder, and a sense amplifier.

3. The artificial intelligence computing device according to claim 2, wherein the control die is configured to move a part of the machine learning model from the dynamic random-access memory to the static random-access memory, and the deep learning processing unit reads the part of the machine learning model from the static random-access memory.

4. The artificial intelligence computing device according to claim 3, wherein when the part of the machine learning model is stored in the static random-access memory, the control die is configured to perform pre-processing on the part of the machine learning model.

5. The artificial intelligence computing device according to claim 4, wherein the pre-processing comprises format conversion and rearrangement.

6. The artificial intelligence computing device according to claim 1, wherein the static random-access memory is arranged in the control die, and the dynamic random-access memory comprises a column decoder, a row decoder, and a sense amplifier.

7. The artificial intelligence computing device according to claim 6, wherein the control die transmits a part of the machine learning model to the deep learning processing unit.

8. The artificial intelligence computing device according to claim 7, wherein the deep learning processing unit stores intermediate data generated by executing the part of the machine learning model in the static random-access memory.

9. The artificial intelligence computing device according to claim 8, wherein after the part of the machine learning model is transmitted to the deep learning processing unit, the deep learning processing unit is configured to perform pre-processing on the part of the machine learning model.

10. The artificial intelligence computing device according to claim 9, wherein the pre-processing comprises format conversion and rearrangement.
